(19) United States
(12) Patent Application Publication
(10) Pub. No.: US 2022/0355672 A1
(43) Pub. Date: Nov. 10, 2022

(54) Electric Vehicle Wind Turbine System

(71) Applicants: Harvey Spence, Belleville (CA); Eleanor Spence, Belleville (CA)

(72) Inventors: Harvey Spence, Belleville (CA); Eleanor Spence, Belleville (CA)

(21) Appl. No.: 17/354,852

(22) Filed: Jun. 22, 2021

Related U.S. Application Data
(60) Provisional application No. 63/185,023, filed on May 6, 2021.

(51) Int. Cl. B60L 8/00; F03D 3/00; F03D 9/25; F03D 9/32

(52) U.S. Cl. CPC B60L 8/006; F03D 3/002; F03D 9/25; F03D 9/32; F05B 2220/706; F05B 2240/941; F05B 2240/14

(57) ABSTRACT

A system for generating electricity using wind power for an electric vehicle (EV). The system converts wind to electricity for charging the EV's primary batteries, or to provide supplemental electricity to other EV systems, such as heating and cooling. The system comprises an air intake that compresses air along a narrowing path to a turbine component. The turbine component comprises a cylinder housing a turbine for capturing the compressed air. As the turbine rotates due to airflow, it engages at least one alternator to generate electricity. The at least one alternator is then connected to the EV's batteries or other vehicle systems for charging or immediate use.

### CROSS-REFERENCE TO RELATED APPLICATION

The present application claims priority to, and the benefit of, U.S. Provisional Application No. 63/185,023, which was filed on May 6, 2021 and is incorporated herein by reference in its entirety.

### FIELD OF THE INVENTION

The present invention generally relates to an electricity generating apparatus, and more specifically to a system for generating supplemental electricity for an electric vehicle. Accordingly, the present specification makes specific reference thereto. However, it is to be appreciated that aspects of the present invention are also equally amenable to other like applications, devices, and methods of manufacture.

### BACKGROUND OF THE INVENTION

Electric vehicles (EV's) are becoming more common due to increasing fuel costs to operate conventional internal combustion engine vehicles. Using vehicles fueled by electricity offers some advantages not available in traditional combustion engine vehicles. Because electric motors react quickly, EVs tend to be more responsive and have very good torque. EVs are also desirable as they reduce the emissions that contribute to climate change and pollution, improving public health and reducing ecological damage. They do not produce tail pipe emissions and are more recyclable than traditional vehicles. However, EV's tend to have long refueling times sometimes taking up to twelve hours or more to acquire a full charge. Additionally, even a full charge does not always produce enough on demand electricity to run the vehicle itself along with other vehicle systems that require power, such as heating and cooling systems, electrically controlled seats, and power windows.

Standard electric vehicle batteries have limited ranges and require frequent charging. Locating an EV charging station while on the road can be challenging due to a limited electrical charging station infrastructure. This requires strategic planning by drivers to ensure that they do not run out of power at an inopportune time. If a EV runs out of battery power, the driver is stranded. This is exacerbated in rural areas or during extreme weather conditions putting occupants at risk if stranded for a long period of time.

Accordingly, there is a great need for way to supply additional power to electric vehicles. There is also a need for a way for an EV to obtain supplemental electricity without a EV charging station. Similarly, there is a need for a way to obtain additional power for the vehicle while driving. Further, there is a need for a way to decrease the likelihood of becoming stranded due to a lack of power in an EV where there are few charging stations.

In this manner, the improved commemorative system of the present invention accomplishes all of the forgoing objectives, thereby providing an easy solution for powering an EV without a charging station. A primary feature of the present invention is an add on system for EV's to generate power while operating the vehicle. The present invention provides piece of mind to EV drivers that they will not become stranded when the traditional battery range runs out. Finally, the present invention is capable of providing additional on demand power to supplement an existing EV battery system to extend driving range and provide additional electricity to other vehicle systems.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an electricity generating system for an electric vehicle (EV). The electricity generating system comprises an air intake component, a turbine, component, and at least one alternator. The air intake component is typically located within and sized to fit a traditional engine compartment of a vehicle. The air intake component comprises a mouth and an outlet connected by a narrowing chamber. The air intake component narrows or tapers along the narrowing chamber to compress airflow within between the mouth and the outlet.

The turbine component comprises a cylindrical casing and a turbine. The turbine component is fed by the air intake component. The cylindrical casing comprises an air inlet and an outlet running between a pair of ends. The air inlet and outlet both extend a length of the cylindrical casing and are diametrically opposed to each other with the air inlet positioned adjacent to the outlet of the air intake component.

The turbine is at least partially encapsulated within the circular casing and extends approximately the length of the cylindrical casing between the pair of ends. The turbine comprises a drum with a plurality of blades, and a rotational shaft extending through the drum along its axis terminating in a pair of shaft ends. Each of the pair of shaft ends terminate in either a mounting pulley or a gear case.

The at least one alternator may be a plurality of alternators. Each alternator is in mechanical communication with the turbine. Each alternator may comprise a mounting pulley or a gear box. Each alternator is mechanically connected to the turbine via a drive belt or a drive shaft. The plurality of alternators may be arranged in parallel on either side of the turbine component or may be arranged in series.

As the EV moves forward, airflow created by the forward motion is directed into the air intake component where it is compressed by the narrowing chamber. The compressed air then enters the air inlet of the cylindrical casing and rotates the turbine converting wind energy into mechanical energy. The mechanical energy is transferred to each alternator via the drive belt or drive shaft where it is converted to electricity. The generated electricity is then transferred to a battery of the EV or is used as on demand electricity to power other EV systems.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an electricity generating system the present invention for generating electricity for an electric vehicle of in accordance with the disclosed architecture.

FIG. 2 illustrates a side cut away view of a turbine component of the electricity generating system the present invention for generating electricity for an electric vehicle of in accordance with the disclosed architecture.

FIG. 3 illustrates a side view of the electricity generating system the present invention for generating electricity for an electric vehicle of in accordance with the disclosed architecture.

FIG. 4 illustrates a side view of the electricity generating system the present invention for generating electricity for an electric vehicle of in accordance with the disclosed architecture.

FIG. 5 illustrates a schematic overhead view of the electricity generating system the present invention for generating electricity for an electric vehicle of in accordance with the disclosed architecture.

FIG. 6 illustrates a schematic overhead view of the turbine component in communication with an alternator of the electricity generating system the present invention for generating electricity for an electric vehicle of in accordance with the disclosed architecture.

FIG. 7 illustrates a side cutaway view of a turbine of the turbine component in communication with the alternator of the electricity generating system the present invention for generating electricity for an electric vehicle of in accordance with the disclosed architecture.

FIG. 8 illustrates a perspective view of the turbine engaging a plurality of alternators via a drive belt of the electricity generating system the present invention for generating electricity for an electric vehicle of in accordance with the disclosed architecture.

FIG. 9 illustrates a schematic overhead view of the turbine in communication with the plurality of alternators of the electricity generating system the present invention for generating electricity for an electric vehicle of in accordance with the disclosed architecture.

FIG. 10 illustrates an overhead schematic view of the turbine in communication with the plurality of alternators via a driveshaft of the electricity generating system the present invention for generating electricity for an electric vehicle of in accordance with the disclosed architecture.

FIG. 11 illustrates an overhead schematic view of the turbine in communication with the plurality of alternators via a plurality of driveshafts of the electricity generating system the present invention for generating electricity for an electric vehicle of in accordance with the disclosed architecture.

FIG. 12 illustrates an overhead schematic view of the turbine in communication with the plurality of alternators via a drive belt and a driveshaft of the electricity generating system the present invention for generating electricity for an electric vehicle of in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is an improved air turbine system for electric vehicles (EV's). The improved air turbine features one or more 500 amp or greater alternators to offer a major charge to the main battery packs to extend the driving range of the EV. The improved air turbine comprises a large air inlet area in the front grill area that tapers into a smaller intake used to compress the air passing into the turbine causing it to spin at a high rate of speed for charging the EV batteries. There is a canister comprising an alternator and a turbine in which the turbine charges the alternator via air pressure as the vehicle moves.

The system compresses air which in turn spins a number of alternators to provide electrical power to charge the main battery pack of an EV. Alternatively, the system can provide electrical power to heat the passenger compartment or to a motor which will turn the compressor for the air conditioner. A large amount of air enters the grill into the chamber as the vehicle moves forward causing compression.

The faster the vehicle moves, the greater the compression. The compression chamber may be shorter or similar in length to an engine compartment of a standard gasoline powered vehicle. The compressed air is fed into a multi-bladed turbine causing it to spin at a high rate of speed. An alternator is attached to one end of the turbine by a pulley or gears at the other end. The size of the unit may be at or near the width of the engine compartment.

A pulley leading to another pulley attached to a drive shaft, or a gear driven mechanism is in communication with the turbine. The drive shaft is typically parallel with the turbine. Several pulleys with belts leading to alternators are in communication with the drive shaft. Each of the alternators will begin to generate power as the speed of the vehicle increases and the air becomes more compressed as the turbine speed increases. Each of the alternators may use a speed clutch for activation as the drive shaft rotation increases. The alternators can activate at certain rates of speed within the vehicle system.

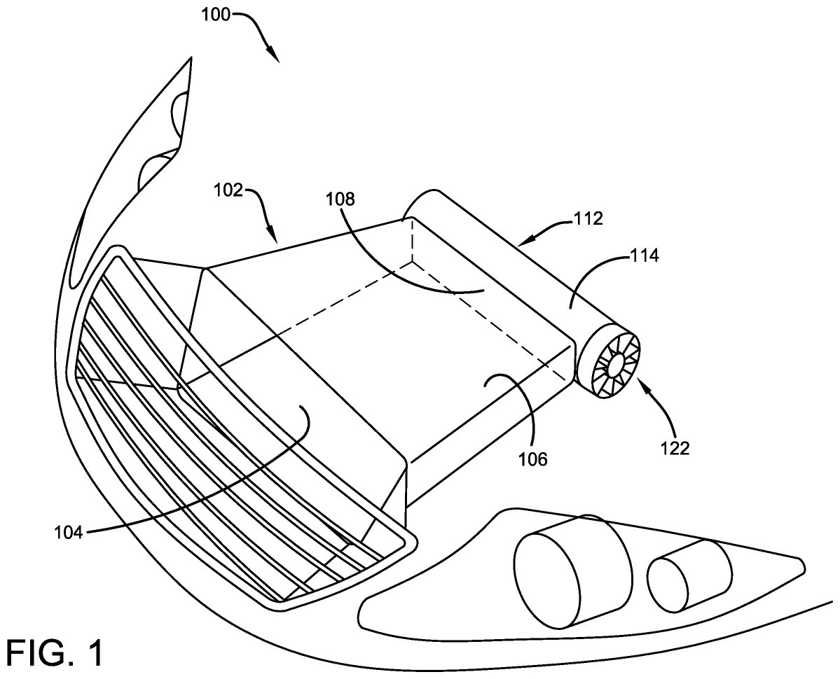

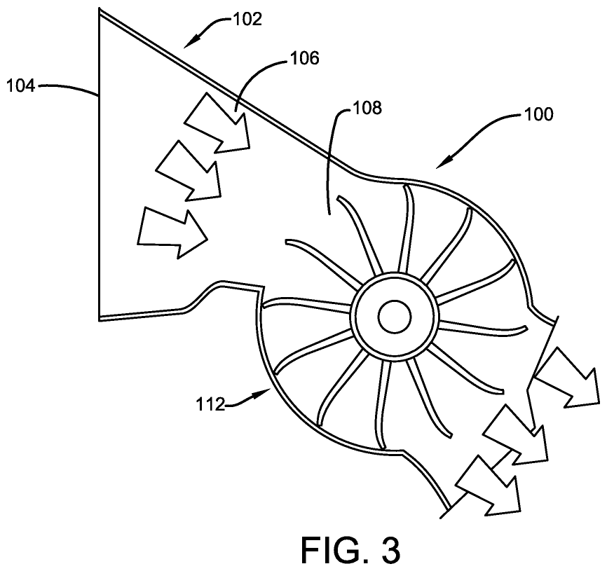

Referring initially to the drawings, FIG. 1-12 illustrate an electricity generating system 100 for an electric vehicle (EV). The electricity generating system 100 comprises an air intake component 102, a turbine, component 112, and at least one alternator 142. As illustrated in FIGS. 1 and 3, the air intake component 102 is typically located within and sized to fit a traditional engine compartment of a vehicle. The air intake component 102 comprises a mouth 104 and an outlet 108 connected by a narrowing chamber 106. The air intake component 102 narrows or tapers along the narrowing chamber 106 to compress airflow within between the mouth 104 and the outlet 108. In one example, the mouth 104 is typically approximately four times larger in area than the outlet 108. For example, if an area of the mouth 104 is approximately 600 square inches, an area of the outlet 108 is approximately 150 square inches. Other ratios may be used as well. The mouth 108 is typically located directly behind a grill or air vents of the EV.

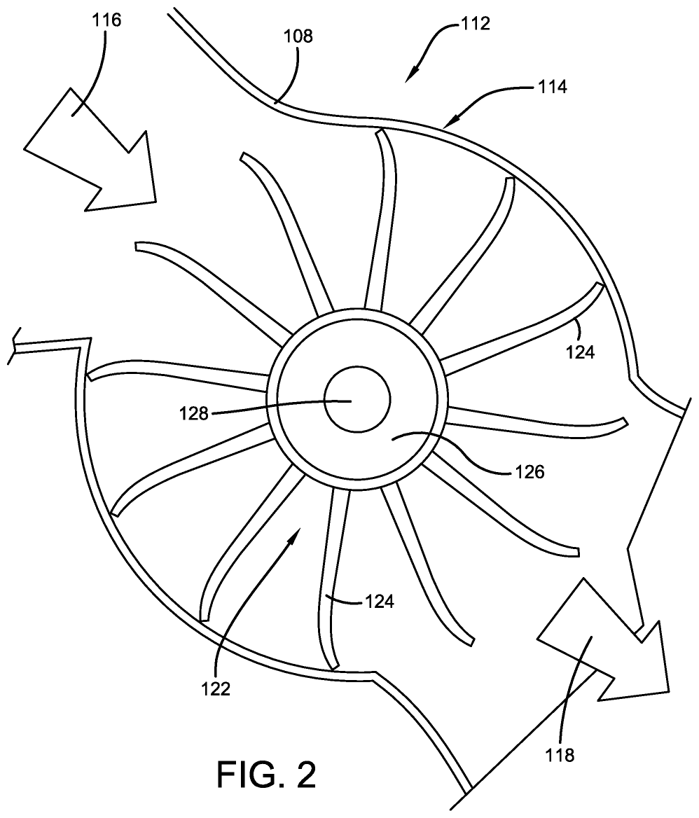

As illustrated in FIG. 2, the turbine component 112 comprises a cylindrical casing 114 and a turbine 122. The turbine component 112 is fed by the air intake component as illustrated in FIG. 3. The cylindrical casing 114 is a shroud or similar tubular housing and comprises an air inlet 116 and an outlet 118 cut into the cylindrical casing 114. The air inlet 116 is similarly sized to the outlet 108 of the air intake component 102 and is also approximately four times smaller in area than the mouth 104 of the air intake component 102.

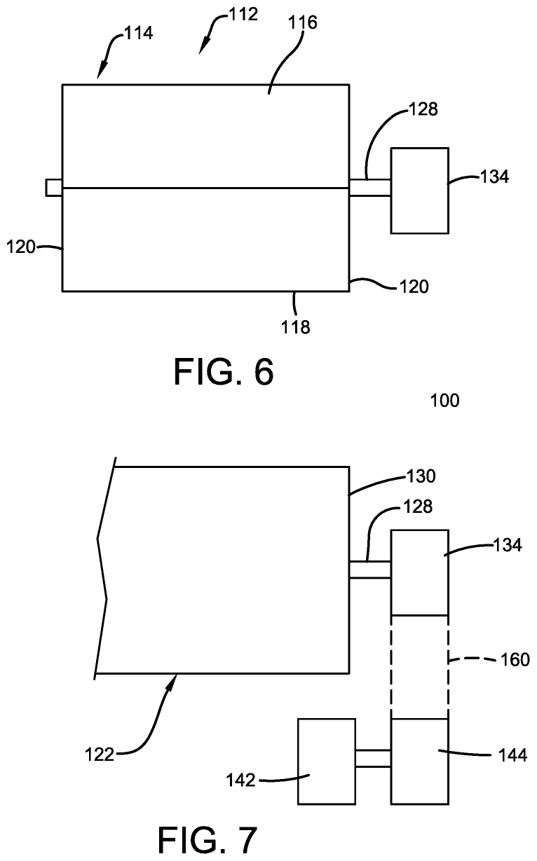

The air inlet 116 and air outlet 118 extend between a pair of ends 120 of the cylindrical casing 114. The air inlet 116 and outlet 118 both run approximately a length of the cylindrical casing 114. The air inlet 116 and outlet 118 are diametrically opposed to each other with the air inlet 116 positioned adjacent to the outlet 108 of the air intake component 102. The cylindrical casing 114 is essentially a closed area that further causes compression as illustrated in FIG. 6.

The turbine 112 is a wind turbine at least partially encapsulated within the circular casing 114. The turbine 112 extends approximately the length of the cylindrical casing 114 between the pair of ends 120. The turbine 122 comprises a drum 126 and a plurality of blades 124 extending from the drum 126 running between a pair of ends 130 and 132. The turbine 122 is typically approximately from seven to twelve inches in diameter (plus or minus) and at least 30 inches in length to extend the length of the air inlet 116 but may be smaller or larger as desired. The turbine 122 is configured to fit snugly within the circular casing 114 with a minimum clearance of approximately one millimeter to allow free rotation of the blades 124 while still causing the air compression before the airflow exits through the outlet 118. The blades 124 are strengthened blades capable of withstanding rotations of at least 10,000 rpm.

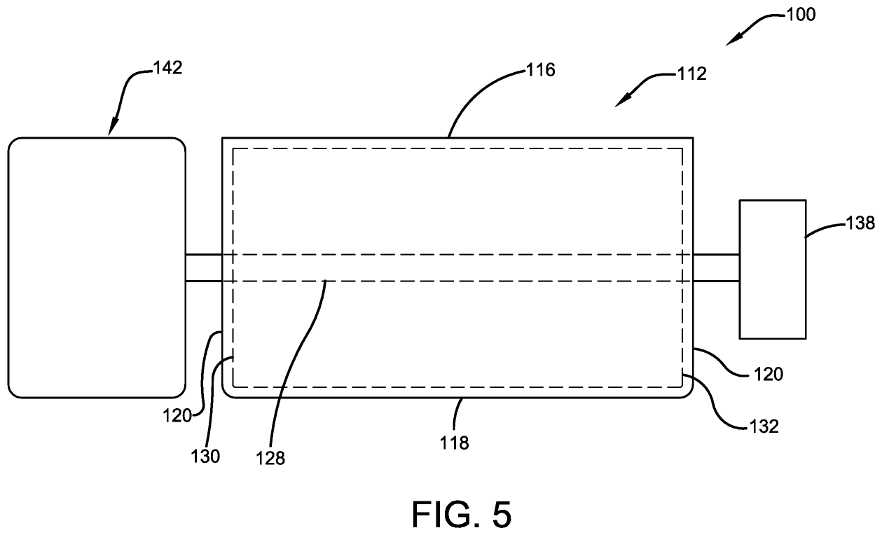

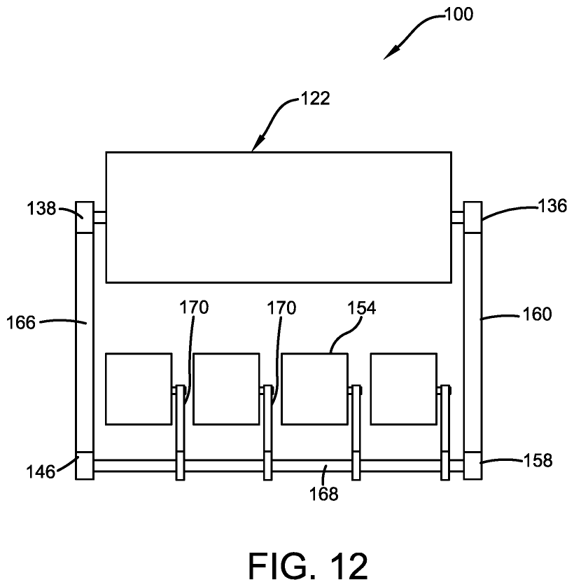

As illustrated in FIGS. 5 and 7, the turbine 122 further comprises a rotational shaft 128. The rotational shaft 128 extends through the drum 126 along its axis and out the pair of ends 130 and 132 of the turbine 122. As illustrated in FIG. 7, one end of the shaft 128 may terminate in a mounting pulley 134. The other end of the shaft 128 may terminate in a second mounting pulley 136 as illustrated in FIGS. 9 and 12. Alternatively, one or both ends of the shaft 128 may terminate in a gear case 138 and 140 as illustrated in FIG. 11.

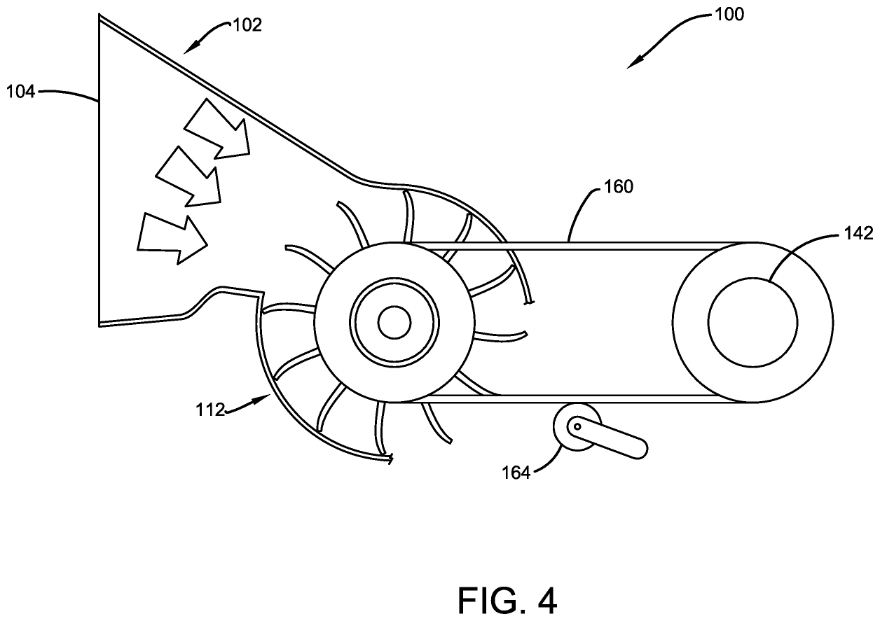

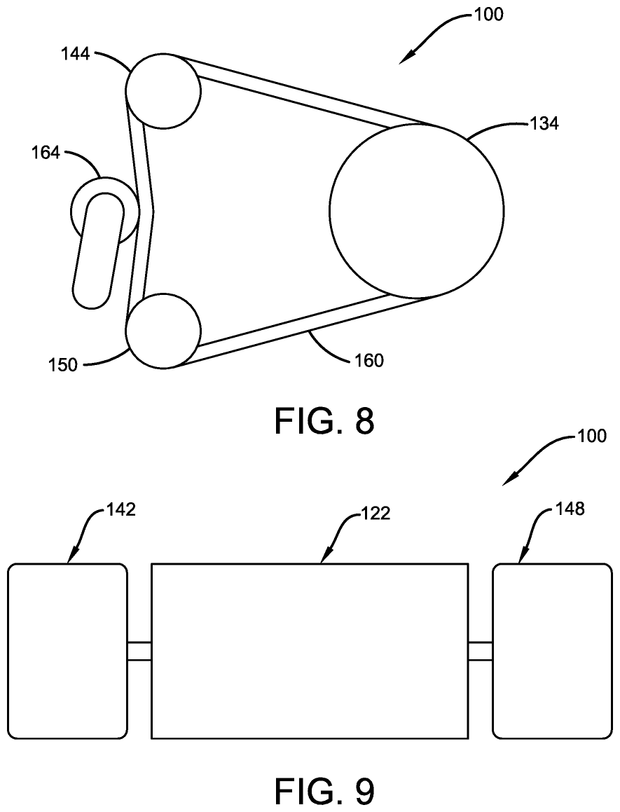

The at least one alternator may be a first alternator 142 as illustrated in FIGS. 4 and 5. The first alternator 142 is located on one side of the cylindrical casing 114 and is in mechanical communication with the turbine 122. The first alternator 142 comprise a mounting pulley 144 as illustrated in FIG. 7. As illustrated in FIGS. 4 and 8, the first alternator 142 is mechanically connected to the turbine 122 via a drive belt 160 to transfer the mechanical energy. The drive belt 160 is a V-belt, flat belt, serpentine belt, or the like configured to mechanically connect the mounting pulley 134 of the shaft 128 to the mounting pulley 144 of the first alternator 144. A belt tensioner 164 or tension adjusting pulley may be positioned along the drive belt 160 to create additional tension.

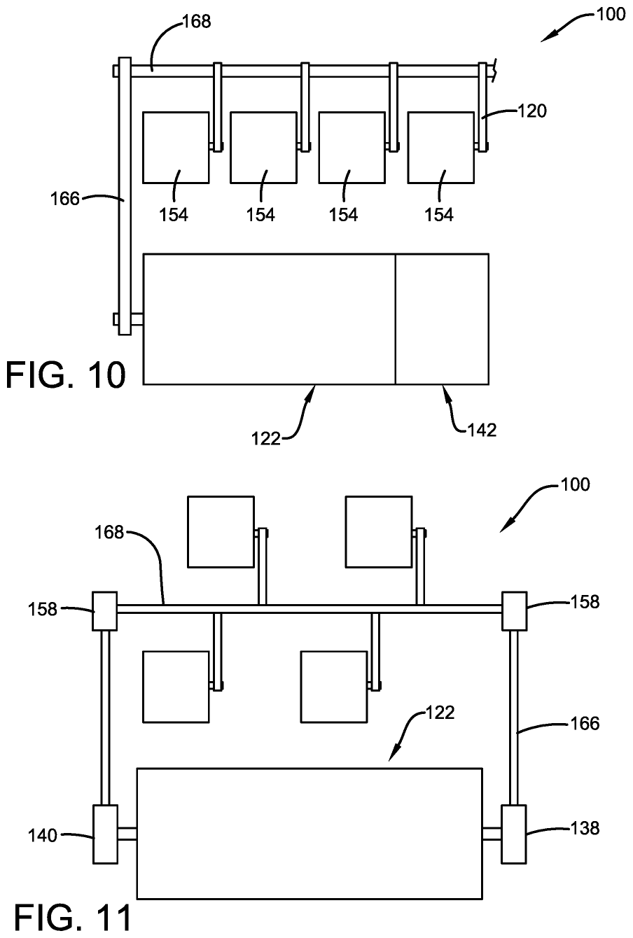

Alternatively, as illustrated in FIG. 5, the first alternator 142 may comprise a gear case 146 in lieu of the mounting pulley 144. In this case, the first alternator 142 is mechanically connected to the turbine 122 via a drive shaft 166 as illustrated in FIG. 10. The drive shaft 166 connects the gear case 138 of the shaft 128 to the gear case 146 of the first alternator 142 to transfer the mechanical energy to the first alternator 142 for conversion to electricity.

The at least one alternator may further comprise a second alternator 148 as illustrated in FIG. 9. The second alternator 148 is located on the opposing side of the cylindrical casing 114 from the first alternator 142 and is also in mechanical communication with the turbine 122. The second alternator 148 is located on the opposing side of the cylindrical casing 114 from the first alternator 142 and is also in mechanical communication with the turbine 122. Similarly, the second alternator 148 comprises either a mounting pulley 150 a or a gear case (similar to 146). The drive belt 160 or an additional drive belt (similar to 160) or drive shaft 168 connects the turbine 122 to the second alternator 148 as described supra. The first and second alternators 142 and 148 are typically at least 500 amp alternators.

As illustrated in FIGS. 10-12, the at least one alternator may be a plurality of alternators 154. Each alternator 154 is in mechanical communication with the turbine 122. Each additional alternator 154 may comprise a mounting pulley (similar to 144) or a gear case 158. Each alternator 154 is mechanically connected to the turbine 122 via the drive belt 160 or the drive shafts 168. The plurality of alternators 154 may be arranged in parallel on either side of the turbine component 112 or may be arranged in series. A plurality of clutch components 174 may be speed or friction clutches in communication with the alternators 154. The plurality of clutch components 174 are configured to activate as the drive shaft rotation increases allowing different alternators 154 to activate at certain rates of speed or the EV. In one example, different alternators 154 could activate at 10 or 15 mph increments to generate additional power as the EV's increased speed allows.

As the EV moves forward, airflow created by the forward motion is directed into the air intake component 102 where it is compressed by the narrowing chamber 106. The compressed air then enters the air inlet 116 of the cylindrical casing 114 and rotates the turbine 122 converting the wind energy into mechanical energy. The mechanical energy is transferred to each alternator 142, 144, or 154 via the drive belt 160 or drive shaft 166 where it is converted to electricity. The generated electricity is then transferred to a battery of the EV or is used directly as on demand electricity to power other EV systems.

Notwithstanding the forgoing, the electricity generating system 100 can be any suitable size, shape, and configuration as is known in the art without affecting the overall concept of the invention, provided that it accomplishes the above stated objectives. One of ordinary skill in the art will appreciate that the shape and size of the electricity generating system 100 and its various components, as show in the FIGS. are for illustrative purposes only, and that many other shapes and sizes of the electricity generating system 100 are well within the scope of the present disclosure. Although dimensions of the electricity generating system 100 and its components (i.e., length, width, and height) are important design parameters for good performance, the electricity generating system 100 and its various components may be any shape or size that ensures optimal performance during use and/or that suits user need and/or preference. As such, the electricity generating system 100 may be comprised of sizing/shaping that is appropriate and specific in regard to whatever the electricity generating system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electricity generating system for an electric vehicle, the system comprising:
an air intake component;
a turbine component fed by the air intake component, the turbine component comprising a cylindrical casing and a turbine partially encapsulated within the cylindrical casing; and
at least one alternator in mechanical communication with the turbine; and
wherein airflow created by motion of the electric vehicle is compressed within the air intake component and rotates the turbine to generate electricity.

2. The system of claim 1, wherein the air intake component comprises a mouth, a narrowing chamber, and an outlet.

3. The system of claim 2, wherein the mouth is approximately four times larger in area than the outlet.

4. The system of claim 1, wherein the air intake component is sized to fit within an engine compartment of the electric vehicle.

5. The system of claim 1, wherein the turbine is mechanically connected to the at least one alternator via a drive belt.

6. The system of claim 1, wherein the turbine is mechanically connected to the at least one alternator via a driveshaft.

7. The system of claim 1, wherein the at least one alternator is configured to convert the transferred mechanical energy from the turbine into electricity.

8. The system of claim 1, wherein the at least one alternator is a 500 amp alternator.

9. The system of claim 1 further comprising a second alternator in mechanical communication with the turbine.

10. An electricity generating system for an electric vehicle, the system comprising:
an air intake component narrowing between a mouth and an outlet;
a turbine component fed by the air intake component, the turbine component comprising a cylindrical casing and a turbine partially encapsulated within the cylindrical casing; and
a plurality of alternators in mechanical communication with the turbine; and
wherein airflow created by motion of the electric vehicle is compressed within the air intake component, enters the cylindrical casing, and rotates the turbine to generate electricity.

11. The system of claim 10, wherein the cylindrical casing comprises an air inlet and an outlet.

12. The system of claim 11, wherein the air inlet runs a length of the cylindrical casing.

13. The system of claim 11, wherein the air inlet is approximately four times smaller in area than the mouth of the air intake component.

14. The system of claim 10, wherein the turbine is seven to twelve inches in diameter.

15. The system of claim 10, wherein the plurality of alternators are each at least 500 amp alternators.

16. The system of claim 10, wherein the turbine is mechanically connected to each of the plurality of alternators via a drive belt or a driveshaft.

17. An electricity generating system for an electric vehicle, the system comprising:
an air intake component comprising a mouth, a narrowing chamber, and an outlet;
a turbine component fed by the outlet of the air intake component, the turbine component comprising a cylindrical casing comprising an air inlet and an outlet diametrically opposed and running a length of the cylindrical casing, and a turbine partially encapsulated within the cylindrical casing; and
a plurality of alternators in mechanical communication with the turbine; and
wherein airflow created by motion of the electric vehicle is compressed by the narrowing chamber, enters the cylindrical casing through the air inlet, and rotates the turbine to generate electricity.

18. The system of claim 17, wherein the turbine is mechanically connected to each of the plurality of alternators via a drive belt, a driveshaft, or a combination thereof.

19. The system of claim 17 further comprising at least one belt tensioner positional between the turbine and one of the plurality of alternators.

20. The system of claim 17 further comprising a plurality of clutch components each in communication with one of the plurality of alternators and activated at different speeds of the electrical vehicle.
